(19) United States
(12) Patent Application Publication
(10) Pub. No.: US 2025/0201878 A1
(43) Pub. Date: Jun. 19, 2025

(54) COLD START SYSTEM OF FUEL CELL VEHICLE AND COLD START CONTROL METHOD OF FUEL CELL VEHICLE

(71) Applicants: Hyundai Motor Company, Seoul (KR); Kia Corporation, Seoul (KR)

(72) Inventors: Jae Ho Han, Suwon-si (KR); Dae Jong Kim, Yongin-si (KR); Jae Ok Ha, Yongin-si (KR)

(21) Appl. No.: 18/658,167

(22) Filed: May 8, 2024

(30) Foreign Application Priority Data
Dec. 18, 2023 (KR) 10-2023-0184669

(51) Int. Cl. H01M 8/04302; H01M 8/04225; H01M 8/04537

(52) U.S. Cl. CPC H01M 8/04302; H01M 8/04225; H01M 8/04559; H01M 8/04619; H01M 8/04626

(57) ABSTRACT

A cold start system of a fuel cell vehicle can include an auxiliary component of a fuel cell vehicle, a fuel cell stack, and a controller that calculates an output voltage of the fuel cell stack based on an available output of the fuel cell vehicle, calculates a voltage offset based on a general performance of the fuel cell stack, and calculates a final voltage by adding up the calculated output voltage and voltage offset of the fuel cell stack.

### CROSS-REFERENCE TO RELATED APPLICATIONS

The present application claims priority to Korean Patent Application No. 10-2023-0184669, filed Dec. 18, 2023, the entire contents of which is incorporated herein for all purposes by this reference.

### TECHNICAL FIELD

The present disclosure relates to a cold start system of a fuel cell vehicle and a cold start control method of a fuel cell vehicle.

### BACKGROUND

A fuel cell is a device that receives hydrogen and air from an outside and generates electrical energy through an electrochemical reaction inside a fuel cell stack. The fuel cell can be used as a power source in various fields, such as fuel cell electric vehicles (FCEV) and fuel cells for power generation.

The fuel cell stack built into a fuel cell vehicle is sensitive to the temperature of the outside air, and in particular, power generation efficiency is significantly reduced at low temperatures. In addition, the water produced by the reaction of hydrogen and oxygen in the fuel cell stack freezes, adversely affecting the durability of the fuel cell stack.

Accordingly, in cases where the temperature of the outside air is low, the fuel cell vehicle performs low-temperature start (cold start). The cold start utilizes loads such as a heating element (COD), air compressor (ACP), and high-voltage battery within the fuel cell system to raise the temperature of the fuel cell stack and induces heat generation from the fuel cell stack and loads to achieve a stable temperature increase.

However, when performing a cold start of a fuel cell vehicle, a fuel cell controller (FCU) transmits output and voltage commands to a DC-DC boost converter to generate heat for the fuel cell stack. Because the command transmitted by the fuel cell controller does not reflect the current state of the vehicle, output exceeding the output that can charge a high-voltage battery may flow into the high-voltage battery, raising concerns about a decrease in durability such as damage to high-voltage battery parts.

The information disclosed in this Background section is only for enhancement of understanding of the general background of the present disclosure and should not be taken as an acknowledgement that this information forms the prior art already publicly known, available, or in use.

### SUMMARY

The present disclosure relates to a cold start system of a fuel cell vehicle and a cold start control method of a fuel cell vehicle.

Some embodiments of the present disclosure can solve the above problems, by providing a cold start system of a fuel cell vehicle and a cold start control method of a fuel cell vehicle that can reflect the state of a vehicle during cold start of a fuel cell vehicle and the status and performance of the fuel cell stack.

A cold start control method of a fuel cell vehicle according to an embodiment of the present disclosure can include calculating an available power of a fuel cell vehicle by a controller, calculating an output voltage of the fuel cell stack based on the calculated available output by the controller, calculating a voltage offset based on a general performance of the fuel cell stack by the controller, and calculating a final voltage by adding up the calculated output voltage and voltage offset of the fuel cell stack by the controller.

In the calculating of the voltage offset, the voltage offset may be calculated based on one or more of a cell voltage ratio (RV) of the fuel cell stack and state of health (SOH) of the fuel cell stack.

In the calculating of the voltage offset, the voltage offset may be calculated by adding the voltage offset according to a cell voltage ratio (RV) of the fuel cell stack and the voltage offset according to state of health (SOH) of the fuel cell stack.

As the cell voltage ratio of the fuel cell stack increases, the voltage offset may decrease.

When the cell voltage ratio of the fuel cell stack decreases below a preset value, the voltage offset may have a constant value.

As the SOH of the fuel cell stack approaches birth of life (BOL), the voltage offset may decrease.

When the SOH of the fuel cell stack decreases below a preset value, the voltage offset may have a constant value.

In the calculating of the voltage offset, a reflection ratio of the voltage offset according to the cell voltage ratio (RV) and voltage offset according to the state of health (SOH) of the fuel cell stack may be determined based on a power generation performance of the fuel cell stack.

As the power generation performance of the fuel cell stack is excellent, the final voltage calculated in the calculating of the final voltage may decrease.

In the calculating of the voltage offset, in a region including one or more of high output, middle output, and low output of a power generation output of the fuel cell stack, the reflection ratio of the voltage offset according to the cell voltage ratio (RV) and voltage offset according to the SOH (State of Health) of the fuel cell stack may be determined based on the power generation performance of the fuel cell stack.

The power generation performance of the fuel cell stack may be determined based on an accumulated number of times the cell voltage ratio (RV) has been operated at a threshold or greater for a certain period of time or more during a preset number of driving cycles.

A history of operating the cell voltage ratio (RV) at the threshold or greater for a certain period of time or more may be extracted from a driving cycle in which the fuel cell stack has been normally operated, before cold start of the fuel cell stack.

The power generation performance of the fuel cell stack may be determined based on an accumulated number of times the cell voltage ratio (RV) has been operated at a threshold value or greater for a certain period of time or more during a preset total power generation time of the fuel cell stack.

In the calculating of the voltage offset, the voltage offset ratio according to the cell voltage ratio (RV) or voltage offset ratio according to the state of health (SOH) of the fuel cell stack may be determined based on a chargeable amount of a battery and a power generation performance of the fuel cell stack measured over a certain period of time.

As the chargeable amount of the battery increases, the final voltage calculated in the calculating of the final voltage may decrease.

In the calculating of the available output of the fuel cell vehicle, the available output may be calculated by adding up one or more of a battery chargeable output, an output of an auxiliary component of the fuel cell vehicle, an output of an air compressor, and an output of COD.

A cold start system of a fuel cell vehicle according to an embodiment of the present disclosure includes an auxiliary component of a fuel cell vehicle, a fuel cell stack, and a controller that calculates an output voltage of the fuel cell stack based on an available output of the fuel cell vehicle, calculates a voltage offset based on a general performance of the fuel cell stack, and calculates a final voltage by adding up the calculated output voltage and voltage offset of the fuel cell stack.

The controller may calculate the voltage offset by adding the voltage offset according to a cell voltage ratio (RV) of the fuel cell stack and the voltage offset according to state of health (SOH) of the fuel cell stack.

The controller may determine a voltage offset ratio according to the cell voltage ratio (RV) or voltage offset ratio according to the state of health (SOH) of the fuel cell stack based on a power generation performance of the fuel cell stack measured over a certain period of time.

The power generation performance of the fuel cell stack may be determined based on an accumulated number of times the cell voltage ratio (RV) has been operated at a threshold value or greater for a certain period of time or more during a preset total power generation time of the fuel cell stack.

According to some embodiments of the cold start system of the fuel cell vehicle and cold start control method of the fuel cell vehicle of the present disclosure, the available output reflecting the state of the fuel cell vehicle can be calculated, and the output voltage of the fuel cell stack can be variably controlled by reflecting the state of the fuel cell stack. Accordingly, some embodiments of the present disclosure can have the advantage of preventing overcharging of the battery and maximizing the likelihood of successful cold start.

### BRIEF DESCRIPTION OF THE DRAWINGS

FIG. 1 is a configuration diagram of a cold start system of a fuel cell vehicle according to an embodiment of the present disclosure.

FIG. 2 is a flowchart of a cold start control method for a fuel cell vehicle according to an embodiment of the present disclosure.

FIG. 3 is a graph showing a voltage offset according to a cell voltage ratio of a fuel cell stack.

FIG. 4 is a graph showing a voltage offset according to SOH of a fuel cell stack.

FIG. 5 is a diagram showing a ratio (a) in a case where a voltage offset according to RV has a negative (−) value.

FIG. 6 is a diagram showing a ratio (a) in a case where a voltage offset according to RV has a positive (+) value.

FIG. 7 is a diagram showing a voltage offset ratio according to an available battery charge output and a short-term characteristic factor of a fuel cell stack in a case where a voltage offset according to RV has a negative (−) value.

FIG. 8 is a diagram showing a voltage offset ratio according to an available battery charge output and a short-term characteristic factor of a fuel cell stack in a case where a voltage offset according to RV has a positive (+) value.

### DETAILED DESCRIPTION OF ILLUSTRATIVE EMBODIMENTS

Hereinafter, example embodiments of the present disclosure will be described in detail with reference to the attached drawings. Same or similar components can be given same reference numbers and redundant description thereof can be omitted.

In the following description, if a detailed description of known techniques associated with the example embodiments of the present disclosure would unnecessarily obscure the gist of the embodiments, detailed description thereof can be omitted. In addition, the attached drawings are provided for easy understanding of example embodiments of the present disclosure and do not necessarily limit technical spirits of the present disclosure, and potential embodiments can be construed as including all modifications, equivalents, and alternatives falling within the spirit and scope of the present disclosure.

While terms, such as “first”, “second”, etc., may be used to describe various components, such components are not necessarily limited by such terms. Such terms can be used merely to distinguish one component from another.

The singular forms are intended to include the plural forms as well, unless the context clearly indicates otherwise.

In the specification, it can be further understood that the terms “comprise” and “include” specify the presence of stated features, integers, steps, operations, elements, components, and/or combinations thereof, but do not preclude in advance the presence or addition of one or more other features, integers, steps, operations, elements, components, and/or combinations.

A controller may include a communication device configured to communicate with other controllers or sensors, a memory (storage medium) configured to store instructions, operating system, logic commands, input and output information, etc., and at least one processor configured to perform determination, calculation, judgement, etc. necessary to control a function assigned to the controller so as to control the function, any combination of or all of which may be in plural or may include plural components thereof.

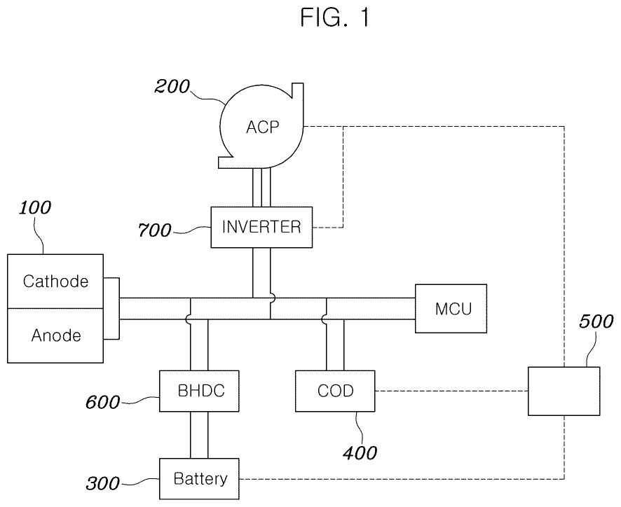

FIG. 1 is a configuration diagram of a cold start system of a fuel cell vehicle according to an embodiment of the present disclosure. Referring to FIG. 1, a cold start system of a fuel cell vehicle can include a fuel cell stack 100 including a cathode and anode, various auxiliary components, a battery 300, an inverter 700, a DC-DC converter 600, a COD 400, an air compressor 200, and a controller 500 that controls a drive motor, etc., any combination of or all of which may be in plural or may include plural components thereof.

The auxiliary components may include energy-using components such as a vehicle's air conditioning system and auxiliary components of a fuel cell stack. The auxiliary components of the fuel cell stack may include the air compressor 200, air flow control valve (ACV), air pressure control valve (APC), and humidifier that constitute an air supply system, a hydrogen pressure valve and hydrogen purge valve that constitute a hydrogen supply system, and the cathode oxygen depletion (COD) 400.

A fuel cell vehicle performs a cold start when an outside temperature falls below a certain level or when it is left in such a state for a long period of time. Although power generation from the fuel cell stack 100 can be required to perform cold start, the power generation output of the fuel cell stack 100 typically cannot be used to drive the fuel cell vehicle. Accordingly, the power generation output of the fuel cell stack 100 can be used to charge the battery 300 of the fuel cell vehicle or can be consumed to drive the air compressor 200 and COD 400.

However, the output that the battery 300 can receive can be limited, and if more than this output flows into the battery 300, it may have a serious adverse effect on the durability of the battery 300. Thus, it can be preferred to perform cold start, considering the state of the battery 300 during cold start. The cold start can refer to an initial start-up section of the fuel cell stack.

In addition, depending on the general performance state of the fuel cell stack 100, the power generation of the fuel cell stack 100 needs to be limited. The general performance of the fuel cell stack refers to the current performance state of the fuel cell stack, which can be expressed by the SOH or cell voltage ratio (RV) of the fuel cell stack.

If the output current of the fuel cell stack 100 can be excessively produced while the general performance of the fuel cell stack 100 can be low, the durability of the fuel cell stack 100 can be weakly affected, so the general performance of the fuel cell stack 100 can also be considered when cold starting a fuel cell vehicle.

Hereinafter, a cold start control method embodiment for a fuel cell vehicle will be described.

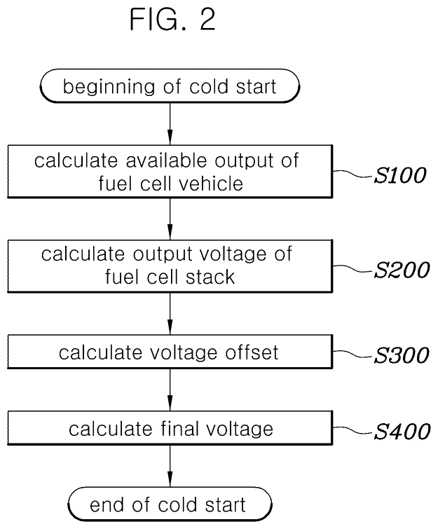

FIG. 2 is a flowchart of a cold start control method for a fuel cell vehicle according to an embodiment of the present disclosure.

A cold start control method of a fuel cell vehicle according to an embodiment of the present disclosure can include calculating an available power of a fuel cell vehicle by the controller 500 (operation S100), calculating an output voltage of the fuel cell stack 100 based on the calculated available output, by the controller 500 (operation S200), calculating a voltage offset based on a general performance of the fuel cell stack 100, by the controller 500 (operation S300), calculating a final voltage by adding up the calculated output voltage and voltage offset of the fuel cell stack, by the controller (operation S400).

The calculating of the available output of the fuel cell vehicle (operation S100) can be a step in which the controller 500 calculates the output required for cold start of the fuel cell vehicle. The available output may be calculated by adding up one or more of the battery chargeable output of the fuel cell vehicle, the output of the auxiliary component of the fuel cell vehicle, the output of the air compressor 200, and the output of the COD 400.

The battery chargeable output can refer to the output that the battery 300 may receive, and may be determined depending on the SOC of the battery 300, the current temperature of the battery 300, etc. The lower the SOC of the battery 300, the higher the battery chargeable output, which can increase the available output of the fuel cell vehicle.

The output of the air compressor 200 can be the output of the air compressor 200 required when injecting air into the fuel cell stack 100, and may be the output required to drive the air compressor 200 at a minimum speed. The output of the air compressor 200 may gradually increase while normalizing the output of the fuel cell stack 100 as the condition of the fuel cell stack 100 can be improved due to the heat generated by the fuel cell stack 100.

The output of the COD 400 can be for heating the coolant passing through the fuel cell stack 100. Specifically, the COD 400 can be a resistor that constitutes the fuel cell system. When output is applied to the COD 400, the coolant passing through the fuel cell stack 100 can be heated according to the heat generated by the COD 400, thereby heating the fuel cell stack 100.

Accordingly, in the step of calculating the available output of the fuel cell vehicle (operation S100), one or more of the outputs can be added to calculate the output required for cold start of the fuel cell vehicle.

The step of calculating the output voltage of the fuel cell stack based on the available output (operation S200) can refer to the step of calculating the output voltage required by the fuel cell stack 100 to produce the calculated available output. Specifically, the output of the fuel cell stack 100 can be calculated as the product of the output voltage and output current. Because the output required from the fuel cell stack 100 can be calculated in the step of calculating the available output of the fuel cell vehicle (operation S100), once the output voltage and output current for producing the output are determined, the calculated available output can be produced.

The output voltage of the fuel cell stack 100 may be determined by the current SOH of the fuel cell stack 100 and the resulting IV curve. The output current may be determined by selecting an IV curve that matches the current SOH of the fuel cell stack 100 to satisfy the required output from the fuel cell stack 100 and selecting an output voltage to satisfy the required output.

However, if the general performance of the fuel cell stack 100 is taken into consideration when determining the output voltage for increasing the temperature of the fuel cell stack 100, there can be an advantage in that cold start can be performed stably and the durability of the fuel cell stack 100 can be protected.

Specifically, if the general performance of the fuel cell stack 100 is superior, cold start can be improved by lowering the output voltage and increasing the output current. If the general performance of the fuel cell stack 100 is poor, the durability of the fuel cell stack 100 can be protected by increasing the output voltage and slightly lowering the output current.

Therefore, in the step of calculating the voltage offset based on the general performance of the fuel cell stack 100 (operation S300), the voltage offset may be calculated according to a degree to which the general performance of the fuel cell stack 100 can be superior or poor.

If the general performance of the fuel cell stack 100 is superior, the voltage offset can be likely to have a negative (−) value, and if the general performance of the fuel cell stack 100 is poor, the voltage offset can be likely to have a positive (+) value.

If the voltage offset is calculated, the step of calculating the final voltage by adding up the calculated output voltage and voltage offset of the fuel cell stack (operation S400) may be performed. Once the final voltage is calculated, the fuel cell stack 100 may perform cold start based on the calculated final voltage.

As described above, in a case of cold start of a fuel cell vehicle, when cold start is performed based on variable control of the output voltage of the fuel cell stack in consideration of the general performance of the fuel cell stack 100, because the general performance of the fuel cell stack 100, which has not been considered in general cold start (a cold start method in which a target voltage of cold start can be preset), can be considered, there are advantages that cold start performance increases, the probability of cold start failure can be reduced, and factors that adversely affect the durability of the fuel cell stack 100 can be reduced.

The step of calculating the voltage offset (operation S300) may calculate the voltage offset based on one or more of the cell voltage ratio (RV) of the fuel cell stack 100 and the state of health (SOH) of the fuel cell stack 100. The cell voltage ratio (RV) of the fuel cell stack 100 or the SOH of the fuel cell stack 100 may be calculated by the controller 500.

Specifically, the general performance of the fuel cell stack 100 may be represented by the cell voltage ratio (RV) of the fuel cell stack 100 and the SOH of the fuel cell stack 100. The cell voltage ratio (RV) of the fuel cell stack 100 can be a value obtained by dividing the minimum voltage of the unit cell constituting the fuel cell stack 100 by an average voltage, and has a value between 0 and 1. The cell voltage ratio (RV) of the fuel cell stack 100 may temporarily drop due to a dry or flooded environment, and may be greatly influenced by external factors. Accordingly, it may refer to the short-term state of the fuel cell stack 100.

In other words, the closer the cell voltage ratio (RV) is to 1, the better the short-term condition of the fuel cell stack 100 is.

The SOH of the fuel cell stack 100 can be information calculated by collecting a large amount of information about the fuel cell stack 100 over a certain period of time, and may mean the average state of the fuel cell stack 100. SOH may have a specific value between birth of life (BOL) and end of life (EOL), and SOH may also have a value from 0 to 1 or from 0% to 100%. The closer SOH is to BOL, the closer it is to 100%, and the closer SOH is to EOL, the value can be between 0 and 60%. The closer the SOH is to the BOL, the better the average condition of the fuel cell stack 100 is.

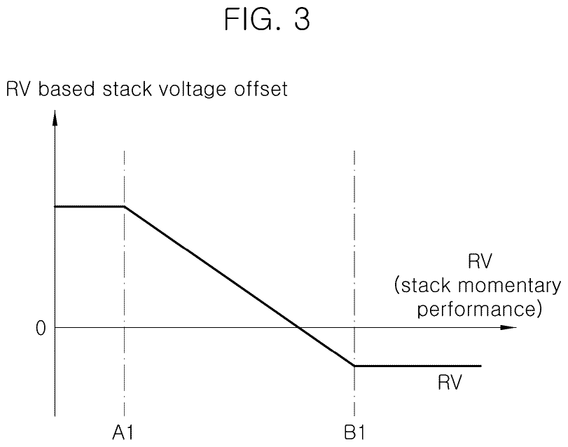

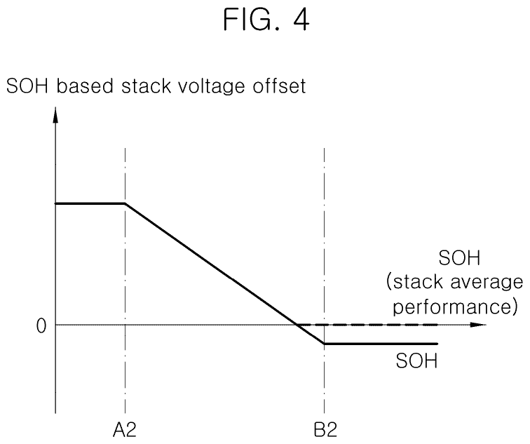

FIG. 3 is a graph showing a voltage offset according to a cell voltage ratio of a fuel cell stack, and FIG. 4 is a graph showing a voltage offset according to SOH of a fuel cell stack. Referring to FIGS. 3 and 4, as the general performance of the fuel cell stack 100, which can be determined by the cell voltage ratio of the fuel cell stack 100 or SOH of the fuel cell stack 100, can be superior, the voltage offset may have a negative (−) value or value that converges to 0.

Referring to FIG. 3, as the cell voltage ratio of the fuel cell stack 100 increases, the voltage offset tends to decrease. In particular, the voltage offset may tend to decrease with a constant slope in the section A1-B1.

However, when the cell voltage ratio of the fuel cell stack 100 decreases below a preset value, the voltage offset may have a constant value. Referring to FIG. 3, even if the cell voltage ratio of the fuel cell stack 100 decreases to A1 or lower and the short-term performance of the fuel cell stack 100 deteriorates, if the voltage offset is continuously increased, it becomes difficult to secure the required calorific value of the fuel cell stack 100 itself. Therefore, it can be preferable to maintain the voltage offset at a voltage that can secure the minimum heat generation required for cold start below the preset value.

Likewise, even if the short-term condition of the fuel cell stack 100 is excellent as the cell voltage ratio is B1 or higher, excessive production of the output current from the fuel cell stack 100 may cause excessive deterioration of the fuel cell stack 100. Therefore, it can be preferable to maintain the voltage offset at a certain level.

Referring to FIG. 4, as the SOH of the fuel cell stack 100 approaches the BOL, the voltage offset may decrease. In particular, the voltage offset may tend to decrease with a constant slope in the section A2-B2.

However, when the SOH of the fuel cell stack 100 decreases below a preset value, the voltage offset may have a constant value. Referring to FIG. 4, even if the SOH of the fuel cell stack 100 decreases to A2 or lower and the average performance of the fuel cell stack 100 deteriorates, if the voltage offset is continuously increased, it becomes difficult to secure the required calorific value of the fuel cell stack 100 itself. Therefore, it can be preferable to maintain the voltage offset at a voltage that can secure the minimum heat generation required for cold start below the preset value.

Likewise, even if the average condition of the fuel cell stack 100 is excellent as the SOH is B2 or higher, excessive production of the output current from the fuel cell stack 100 may cause excessive deterioration of the fuel cell stack 100. Therefore, it can be preferable to maintain the voltage offset at a certain level.

Here, the minimum value of the voltage offset by SOH may have a negative (−) value or may be 0. In other words, the lower limit of the voltage offset according to SOH may be controlled to maintain cold start performance by setting it to 0, or the lower limit of the voltage offset according to SOH may be set to a negative (−) value to control the cold start performance to be further secured.

Any one of the voltage offsets calculated as above may be used to calculate the final voltage by adding it to the output voltage of the fuel cell stack 100. For example, the final voltage may be calculated by adding up the voltage offset by the cell voltage ratio of the fuel cell stack 100 and the output voltage of the fuel cell stack 100, or the final voltage may be calculated by adding up the voltage offset by the SOH of the fuel cell stack 100 and the output voltage of the fuel cell stack 100.

However, when calculating the final voltage, it can be preferable to consider both the cell voltage ratio of the fuel cell stack 100 and the SOH of the fuel cell stack 100 from the viewpoint of considering the general performance of the fuel cell stack 100 in various aspects.

Therefore, in the step of calculating the voltage offset (operation S300), the voltage offset according to the cell voltage ratio (RV) of the fuel cell stack 100 and the voltage offset according to the SOH of the fuel cell stack 100 can be added together. The final voltage may be calculated by adding the calculated voltage offset to the output voltage of the fuel cell stack 100.

Here, because both the cell voltage ratio of the fuel cell stack 100 and the SOH of the fuel cell stack 100 are considered, the voltage offset may be calculated by multiplying each calculated voltage offset by a constant.

In other words, the final voltage offset may be calculated as shown in Equation 1 below.

$$Z = aX + ( 1 - a ) Y \\ Z : Final voltage offset \\ X : Voltage offset by RV \\ Y : Voltage offset by SOH \\ a : Offset reflection ratio , constant between 0 and 1 \qquad Equation 1$$

It can be preferred to determine the reflection ratio in the relationship between the voltage offset by RV and the voltage offset by SOH. In other words, a and 1-a are required to be determined in the above formula. Therefore, in the step of calculating the voltage offset (operation S300), it can be preferred to determine the voltage offset ratio according to the cell voltage ratio (RV) or voltage offset ratio according to the SOH of the fuel cell stack 100.

To determine the ratio, the cell voltage ratio of the fuel cell stack 100 can be primarily considered. The voltage offset ratio (a in Equation 1) according to the cell voltage ratio of the fuel cell stack 100 preferentially reflects the operation history of the fuel cell stack 100 in a high output section. Thus, even if the average performance of the fuel cell stack 100 deteriorates, the short-term performance of the fuel cell stack 100 may be preferentially considered.

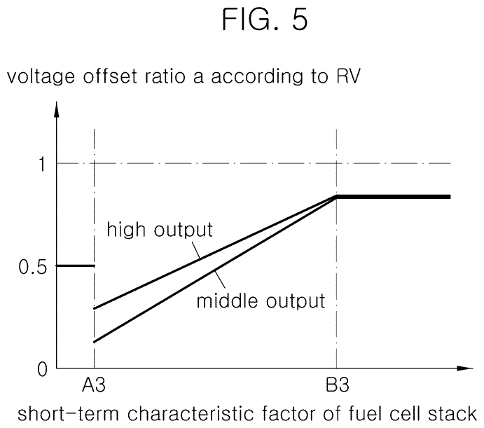

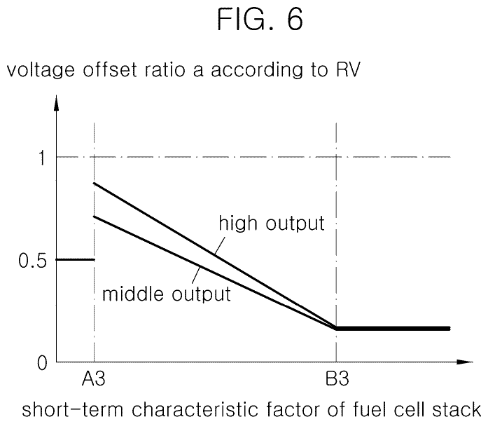

FIG. 5 is a diagram showing a ratio (a) in case where a voltage offset according to RV has a negative (−) value. FIG. 6 is a diagram showing a ratio (a) in case where a voltage offset according to RV has a positive (+) value.

The determination of the voltage offset ratio will be described in detail with reference to FIGS. 5 and 6.

First, the short-term characteristic factor of the fuel cell stack that constitutes the X-axis of the graphs in FIGS. 5 and 6 will be described. The short-term characteristic factor of the fuel cell stack 100 refers to the short-term power generation performance of the fuel cell stack 100. That is, if the short-term power generation performance of the fuel cell stack 100 is superior, the short-term characteristic factor of the fuel cell stack 100 has a high value, and if the short-term power generation performance of the fuel cell stack 100 is poor, the short-term characteristic factor of the fuel cell stack 100 has a low value.

The short-term characteristic factor of the fuel cell stack 100, that is, the power generation performance of the fuel cell stack 100, may be determined based on the number of times the fuel cell stack 100 has been operated for a certain period of time at a cell voltage ratio (RV) of a threshold value or higher.

For example, the short-term characteristic factor of the fuel cell stack 100 may be determined based on the accumulated number of times the fuel cell stack or vehicle has been operated for 1 second or more with a cell voltage ratio (RV) of 0.9 or more during 40 driving cycles.

More specifically, in a region where the power generation output of the fuel cell stack 100 can be divided into one or more of high output, medium output, and low output regions, during a preset plurality of driving cycles, the cell voltage ratio (RV) of the fuel cell stack 100 may be determined based on the accumulated number of times the fuel cell stack 100 has been operated at or greater than a threshold value for a certain period of time.

In this case, the history of the cell voltage ratio (RV) of the fuel cell stack 100 may be extracted before cold start of the fuel cell stack can be performed, that is, in a cycle in which the fuel cell stack can be normally operated.

For example, in the “high output” region, the short-term characteristic factor of the fuel cell stack 100 may be determined based on the number of times the fuel cell stack 100 has been operated at an RV of “0.9” or greater for “1 second” or more during “40 driving cycles.”

If there is no data on the previous operation history of the fuel cell stack 100 in the “high output” region, in the “medium output” region, the short-term characteristic factor of the fuel cell stack 100 may be determined based on the number of times the fuel cell stack 100 has been operated at an RV of “0.95” or greater for “10 second” or more during “40 driving cycles.”

Alternatively, the short-term characteristic factor of the fuel cell stack 100, that is, the power generation performance of the fuel cell stack 100, may be determined based on the accumulated number of times the cell voltage ratio (RV) has been operated at a threshold value or greater for a certain period of time or more during the total power generation time of the fuel cell stack. In this case, the accumulated number of times can be measured based on the total power generation time rather than the driving cycle.

In this way, through the history of the cell voltage ratio (RV) of the fuel cell stack 100, the short-term characteristic factor of the fuel cell stack may be determined based on the past normal operation history of the fuel cell stack, rather than the current cell voltage ratio of the fuel cell stack where cold start can be performed,

In other words, the short-term characteristic factor of the fuel cell stack may be determined by estimating the performance that the fuel cell stack 100 can exhibit during cold start through the past operation history of the fuel cell stack.

Once the short-term characteristic factor of the fuel cell stack 100 is determined, the voltage offset ratio (a) according to RV corresponding to a graph corresponding to high output or medium output may be determined, and the voltage offset ratio (1-a in Equation 1) according to SOH may also be determined.

If there is insufficient data for the region in which the fuel cell stack 100 can be operated in any output region, the voltage offset ratio (a) according to RV may be set to 0.5.

The better the power generation performance of the fuel cell stack 100 measured over a certain period of time, the final voltage calculated in the step of calculating the final voltage (S400) should tend to decrease. Therefore, as in FIG. 5, when the voltage offset according to RV has a negative (−) value, the graph can be sloping upward to the right. As shown in FIG. 6, when the voltage offset according to RV has a positive (+) value, the graph can be sloping downward to the right.

In summary, the following implementation examples in Table 1 below may be presented depending on the short-term performance of the fuel cell stack according to RV and the high or low average performance of the fuel cell stack according to SOH.

TABLE 1

| | Short-term performance of a fuel | Average performance |
|---|---|---|
| | cell stack | of a fuel cell stack |
| Implementation | High | High |
| Example 1 | | |
| Implementation | High | Low |
| Example 2 | | |
| Implementation | Low | High |
| Example 3 | | |
| Implementation | Low | Low |
| Example 4 | | |

According to Implementation Example 1, in case where both the short-term performance and average performance of the fuel cell stack are high, the voltage offset can be calculated to a low value and the final voltage (a) may be controlled low to secure cold start performance.

According to Implementation Example 2, in case where the short-term performance of the fuel cell stack is high, but the average performance of the fuel cell stack is low, the final voltage (b) can be controlled to be slightly higher in further consideration of the short-term performance of the fuel cell, so that stable cold start performance may be expected.

According to Implementation Example 3, in case where the short-term performance of the fuel cell stack is low, but the average performance of the fuel cell stack is high, the final voltage (c) can be controlled to be slightly higher in further consideration of the average performance of the fuel cell, so that stable cold start performance may be expected.

According to Implementation Example 4, in case where both the short-term performance and average performance of the fuel cell stack are low, the voltage offset can be calculated to a high value and the final voltage (d) may be controlled to be high to secure stable cold start performance.

According to the above implementation examples, the relationship between final voltages tends to be a<<c≤b<<d.

According to an embodiment, the voltage offset ratio according to the cell voltage ratio (RV) or voltage offset ratio according to the SOH of the fuel cell stack 100 may be determined by considering the chargeable amount (available battery charge output) of the battery 300 together.

That is, when the SOC of the battery 300 is significantly low and the output that the battery 300 may receive is sufficient, the output produced by the fuel cell stack 100 may be consumed through charging the battery 300. Therefore, this can correspond to a situation where it can be possible to lower the output voltage of the fuel cell stack 100 and increase the output current. If the SOC of the battery 300 is full, there can be no output that the battery 300 may receive, and the output produced by the fuel cell stack 100 typically cannot be consumed through charging the battery 300. Therefore, this can correspond to a situation in which the output voltage of the fuel cell stack 100 should not be lowered.

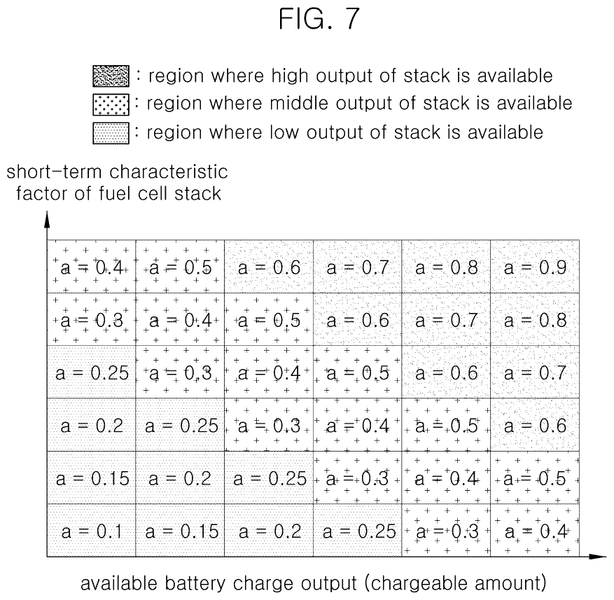

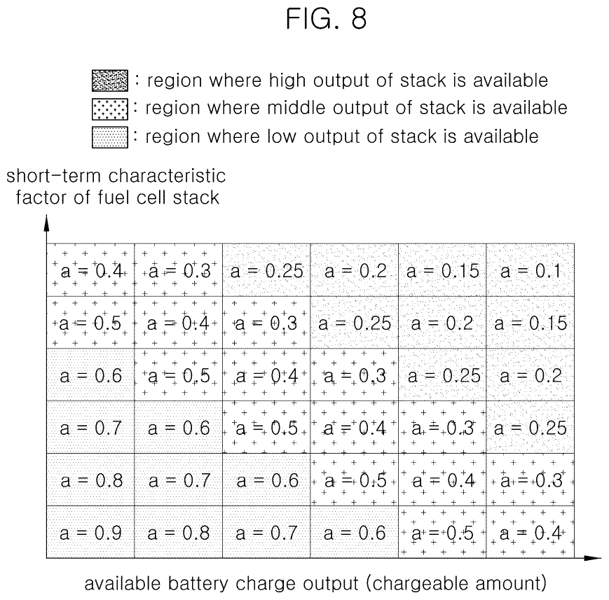

In another embodiment in which the voltage offset ratio according to the cell voltage ratio (RV) or voltage offset ratio according to the SOH of the fuel cell stack 100 can be determined based on the chargeable amount of the battery 300 and power generation performance of the fuel cell stack 100 measured over a certain period of time, the voltage offset ratio may be determined as shown in the graphs shown in FIGS. 7 and 8.

FIG. 7 is a diagram showing a voltage offset ratio according to an available battery charge output and a short-term characteristic factor of a fuel cell stack in case where a voltage offset according to RV has a negative (−) value. FIG. 8 is a diagram showing a voltage offset ratio according to an available battery charge output and a short-term characteristic factor of a fuel cell stack in case where a voltage offset according to RV has a positive (+) value.

Referring to FIG. 7, because the voltage offset according to RV has a negative value, the short-term performance of the fuel cell stack is excellent. Accordingly, if the available battery charge output is sufficient and the short-term characteristic factor of the fuel cell stack 100 also has a high value, the use of the short-term performance of the fuel cell stack 100 can be relatively dominant, so that the voltage offset according to RV may greatly contribute to determining the final voltage.

Conversely, if the available battery charge output is insufficient and the short-term characteristic factor of the fuel cell stack 100 also has a low value, the use of the average performance of the fuel cell stack 100 can be relatively dominant, and thus, the voltage offset according to SOH may greatly contribute to determining the final voltage.

Referring to FIG. 8, because the voltage offset according to RV has a positive value, the short-term performance of the fuel cell stack 100 can be deteriorated. Accordingly, even if the available battery charge output is sufficient and the short-term characteristic factor of the fuel cell stack 100 is also high, the use of the average performance of the fuel cell stack 100 can be relatively dominant, so that the voltage offset according to SOH may greatly contribute to determining the final voltage.

Conversely, if the available battery charge output is insufficient and the short-term characteristic factor of the fuel cell stack 100 also has a low value, the use of the short-term performance of the fuel cell stack 100 can be relatively dominant, and thus, the voltage offset according to RV may greatly contribute to determining the final voltage.

Although the present disclosure has been illustrated and described in connection with some specific example embodiments and the accompanying drawings, it can be readily understood by those skilled in the art that various modifications and changes can be made thereto without departing from the spirit and scope of the present disclosure defined by the appended claims.

What is claimed is:

1. A cold start control method of a fuel cell vehicle comprising:
determining an available power of the fuel cell vehicle;
determining an output voltage of a fuel cell stack based on the determining of the available output;
determining a voltage offset based on a general performance of the fuel cell stack; and
determining a final voltage by summing the output voltage and the voltage offset of the fuel cell stack.

2. The method of claim 1, wherein the determining of the voltage offset is based on one of or both of a cell voltage ratio (RV) of the fuel cell stack and a state of health (SOH) of the fuel cell stack.

3. The method of claim 1, wherein the determining of the voltage offset is calculated by adding a first voltage offset according to a cell voltage ratio (RV) of the fuel cell stack and a second voltage offset according to a state of health (SOH) of the fuel cell stack.

4. The method of claim 3, wherein as the cell voltage ratio of the fuel cell stack increases, the first voltage offset decreases.

5. The method of claim 4, wherein in response to the cell voltage ratio of the fuel cell stack decreasing below a preset value, the first voltage offset has a constant value.

6. The method of claim 3, wherein as the state of health of the fuel cell stack approaches birth of life (BOL), the voltage offset decreases.

7. The method of claim 6, wherein in response to the state of health of the fuel cell stack decreasing below a preset value, the second voltage offset has a constant value.

8. The method of claim 3, wherein the determining of the voltage offset comprises determining a reflection ratio of the first voltage offset according to the cell voltage ratio (RV) and the second voltage offset according to the state of health (SOH) of the fuel cell stack, based on a power generation performance of the fuel cell stack.

9. The method of claim 8, wherein in response to the power generation performance of the fuel cell stack being better, the final voltage calculated by the determining of the final voltage decreases.

10. The method of claim 8, wherein, in a region including one of or any combination of a high output, a middle output, and a low output of the power generation output of the fuel cell stack, the reflection ratio is determined based on the power generation performance of the fuel cell stack.

11. The method of claim 8, wherein the power generation performance of the fuel cell stack is determined based on an accumulated number of times the cell voltage ratio (RV) has been operated at a threshold value or greater, for a set period of time or more, during a preset number of driving cycles.

12. The method of claim 11, wherein a history of operating the cell voltage ratio (RV) at the threshold value or greater, for the set period of time or more, is extracted from a driving cycle in which the fuel cell stack has been operated before a given cold start of the fuel cell stack.

13. The method of claim 8, wherein the power generation performance of the fuel cell stack is determined based on an accumulated number of times the cell voltage ratio (RV) has been operated at a threshold value or greater, for a set period of time or more, during a preset total power generation time of the fuel cell stack.

14. The method of claim 2, wherein the determining of the voltage offset comprises determining the voltage offset ratio, according to the cell voltage ratio (RV) or according to the state of health (SOH) of the fuel cell stack, is based on a chargeable amount of a battery and a power generation performance of the fuel cell stack measured over a set period of time.

15. The method of claim 14, wherein in response to the chargeable amount of the battery increasing, the final voltage decreases.

16. The method of claim 1, wherein the determining of the available output of the fuel cell vehicle comprises summing one of or any combination of a battery chargeable output, an auxiliary component output of an auxiliary component of the fuel cell vehicle, an air compressor output of an air compressor, and a cathode oxygen depletion output of a cathode oxygen depletion device.

17. A cold start system of a fuel cell vehicle comprising:
an auxiliary component of the fuel cell vehicle;
a fuel cell stack;
one or more controllers; and
a storage medium storing computer-readable instructions that, when executed by the one or more controllers, enable the one or more controllers to
calculate an output voltage of the fuel cell stack based on an available output of the fuel cell vehicle,
calculate a voltage offset based on a general performance of the fuel cell stack, and
calculate a final voltage by adding up the calculated output voltage and voltage offset of the fuel cell stack.

18. The system of claim 17, wherein the instructions further enable the one or more controllers to calculate the voltage offset by adding a first voltage offset according to a cell voltage ratio (RV) of the fuel cell stack and a second voltage offset according to state of health (SOH) of the fuel cell stack.

19. The system of claim 18, wherein the instructions further enable the one or more controllers to determine a voltage offset ratio according to the cell voltage ratio (RV) or according to the state of health (SOH) of the fuel cell stack, based on a power generation performance of the fuel cell stack measured over a set period of time.

20. The cold start system of claim 19, wherein the instructions further enable the one or more controllers to determine the power generation performance of the fuel cell stack based on a number of times the cell voltage ratio (RV) has been operated at a threshold value or greater for a preset total power generation time period.
